(19) United States
(12) Patent Application Publication
(10) Pub. No.: US 2025/0043394 A1
(43) Pub. Date: Feb. 6, 2025

(54) NICKEL-BASED ALLOY

(71) Applicants: SAFRAN, PARIS (FR); AUBERT & DUVAL, ISSY-LES-MOULINEAUX (FR)

(72) Inventors: Anne-Laure ROUFFIE, MOISSY-CRAMAYEL (FR); Jean-Michel Patrick Maurice FRANCHET, MOISSY-CRAMAYEL (FR); Edern MENOU, MOISSY-CRAMAYEL (FR); Coraline CROZET, ORCINES (FR); Laurane FINET, CLERMONT-FERRAND (FR)

(21) Appl. No.: 18/718,738

(22) PCT Filed: Dec. 14, 2022
(86) PCT No.: PCT/FR2022/052356

§ 371 Date: Jun. 11, 2024

(30) Foreign Application Priority Data
Dec. 15, 2021 (FR) 2113444

(51) Int. Cl. C22C 19/05; C22F 1/10; F01D 25/24

(52) U.S. Cl. CPC C22C 19/056; C22F 1/10; F01D 25/24; F05D 2240/14; F05D 2300/175

(57) ABSTRACT

A nickel-based alloy includes, in weight percent: 4.0 to 15.7% cobalt, 15.3 to 19.5% chromium, 1.6 to 5.45% molybdenum, 1.65 to 2.5% aluminum, 2.8 to 4.3% titanium, 0.01 to 0.10% carbon, 0.003 to 0.02% boron, and 0.01 to 0.10% zirconium. A method for manufacturing a part made of the nickel-based alloy includes preparing a billet which has the same composition as that of the nickel-based alloy, shaping the part, and heat treating the part.

### FIELD OF THE INVENTION

This invention relates to nickel-based alloys. More particularly, this invention relates to nickel-based alloys specifically designed for an application in turbine casings for aeronautical engines.

### PRIOR ART

The objectives of ACARE, in line with the European Union's Green Deal for Europe, as well as the requirements for reducing the ownership costs imposed by aircraft manufacturers, are forcing engine manufacturers to significantly increase the performance of new-generation turbojets, in particular with a large reduction in specific consumption. This translates into a need to improve engine efficiency by reducing the ventilation of hot engine parts. As a result, materials will need to withstand increasingly hotter operating temperatures.

For example, in the case of a low-pressure turbine casing, certain areas are subjected both to fatigue and to creep at very high temperatures, the target being 800° C. with peaks at 850° C. for new-generation engines. However, a longer fatigue life is favored by a fine grain size (around 10 according to the ASTM E112 standard, abbreviated below as ASTM), while the best creep resistance is obtained with coarse-grained microstructures (around ASTM 0). A compromise is therefore necessary between these two antagonistic properties.

Today, the main known alloys for aeronautical turbine casing applications are Inconel 718, 718 Plus, and Waspaloy. Their maximum operating temperatures are around 650° C., 704° C., and 750° C. respectively. Beyond that, their mechanical properties drop due to a softening of their microstructure. These alloys are therefore not designed to withstand temperatures of around 800° C. over long periods of time.

Other alloys stemming from powder metallurgy allow reaching these high operating temperatures: for example, the alloy described in EP 1 840 232 Bl. However, this alloy contains more than 43 vol. % of γ′ precipitates and its ductility is insufficient to consider ring rolling shaping, a technique used for the manufacture of parts such as turbine casings for aeronautical engines. The current upper limit that is commonly accepted is indeed around 40% of γ′ precipitates.

This is why Waspaloy, an alloy containing 25 vol. % of γ′ precipitates (in which the nominal composition is, in weight percent: Cr 18.00-21.00, Co 12.00-15.00, Mo 3.50-5.00, Al 1.20-1.60, Ti 2.75-3.25, B 0.003-0.01, C 0.02-0.10, Zr 0.02-0.08, Fe 0-2.00, Mn 0-0.10, Si 0-0.15, P 0-0.015, S 0-0.015, and Cu 0-0.10), is currently the one which allows the best compromise between fatigue life and creep resistance at high temperatures. This compromise is achieved by obtaining an intermediate grain size (between ASTM 2 and 6) over the entire part. But once again, this alloy was not designed to withstand an operating temperature of 800° C. for very long periods of time.

Some alloys with 36 vol. % of γ′ precipitates, such as AD730™ or Rene65, could have better properties than Waspaloy, but currently they do not allow reaching an intermediate and homogeneous grain size over large parts. Their grain size, which is solely controlled by the populations of primary γ′ precipitates, grows very quickly indeed when the temperature exceeds the γ′ solvus. Avoiding this excessive growth in grain size would require precise control to the nearest degree of the heat treatment temperature over the entire part, which is not achievable in an industrial furnace.

Thus, at present, there is no alloy which combines better heat resistance than Waspaloy, the ability to be shaped by ring rolling, and the ability to reach a homogeneous and intermediate grain size over the entire part through heat treatment to ensure the compromise between creep resistance and fatigue life necessary for the intended application.

There is therefore a need to have a new alloy which can meet the need to increase the operating temperature of the part, while retaining a method of manufacturing by ring rolling and without degrading the fatigue life in comparison to Waspaloy.

### SUMMARY OF THE INVENTION

Thus, one of the objectives of this invention is to overcome at least one of the disadvantages mentioned above.

For this purpose, the invention provides a nickel-based alloy comprising, in weight percent:
4.0 to 15.7% cobalt;
15.3 to 19.5% chromium;
1.6 to 5.45% molybdenum;
1.65 to 2.5% aluminum;
2.8 to 4.3% titanium;
0.01 to 0.10% carbon;
0.003 to 0.02% boron; and
0.01 to 0.10% zirconium.

Other optional and non-limiting features are as follows.

The nickel-based alloy may comprise, in weight percent:
0.02 to 0.06% carbon;
0.005 to 0.01% boron; and
0.02 to 0.06% zirconium.

The nickel-based alloy may comprise, in weight percent:
1.65 to 2.10% aluminum; and
2.8 to 3.45% titanium.

The nickel-based alloy may comprise, in weight percent:
4.0 to 13.2% cobalt;
1.80 to 2.30% aluminum; and
3.5 to 4.0% titanium.

The nickel-based alloy may comprise, in weight percent:
4.0 to 11.0% cobalt;
2.0 to 2.50% aluminum; and
4.05 to 4.4% titanium.

The nickel-based alloy may comprise 6.0 weight % or less of iron, preferably 4.0 weight % or less.

The nickel-based alloy may comprise 6.3 weight % or less of tungsten.

The nickel-based alloy may comprise 0.4 weight % or less of niobium.

Furthermore, the present invention provides a method for processing such an alloy, comprising:
manufacturing a billet which has the same composition as that of the nickel-based alloy;
shaping the part; and
heat treating the part.

Other optional and non-limiting features are as follows.

Manufacturing the billet may comprise:
producing an ingot, preferably by a melting of materials; and
converting the ingot into billets, preferably by cutting the ingot then forging.

Shaping the part may comprise:
forging the billet, preferably by upset forging;
rolling the forged billet, preferably by ring rolling.

Heat treating the part may comprise at least one treatment among:
a γ′ supersolvus solution heat treatment, preferably at a temperature that is 10 to 40° C. higher than the γ′ solvus; and
a γ′ subsolvus solution heat treatment, preferably at a temperature that is 10 to 40° C. lower than the γ′ solvus.

The heat treatment may further comprise:
a tempering to precipitate M₂₃C₆ type carbides, preferably by heating at a temperature between 825 and 870° C.; and
optionally a tempering to stabilize the populations of γ′ precipitates, preferably at a temperature between 76° and 825° C.

The invention also proposes an aeronautical part made of the alloy described above, in particular a turbine casing.

The nickel-based alloys according to the invention are suitable for the manufacture of parts intended to withstand temperatures of around 800° C. in their hottest portions and temperature spikes of up to 850° C., while maintaining good fatigue resistance over the whole parts.

This compromise is made possible due to controlling the grain size by heat treatment and forging, which allows obtaining an intermediate grain size of ASTM 2 to 6. The alloy is also suitable for vacuum casting and for ring rolling shaping, techniques which allow reducing manufacturing costs compared to other pathways such as powder metallurgy or direct manufacturing.

### BRIEF DESCRIPTION OF FIGURES

Other objectives, features, and advantages will become apparent upon reading the description with reference to the drawings presented below.

FIG. 1 is a diagram showing the steps of the method for manufacturing a part made of a nickel-based alloy according to the invention.

FIG. 2 is a diagram showing an example of the billet manufacturing sub-steps of the method according to the invention.

FIG. 3 is a diagram showing an example of the ingot production sub-steps of the billet manufacturing step.

FIG. 4 is a diagram showing an example of the ingot-to-billet conversion sub-steps in the billet manufacturing step.

FIG. 5 is a diagram showing an example of the part-shaping sub-steps of the method according to the invention.

FIG. 6 is a diagram showing a first example of the heat treatment sub-steps of the method according to the invention.

FIG. 7 is a diagram showing a second example of the heat treatment sub-steps of the method according to the invention.

FIG. 8 is a diagram showing a third example of the heat treatment sub-steps of the method according to the invention.

FIG. 9 is a diagram showing the grain boundaries and the carbide precipitates in an alloy according to the invention after treatment according to the treatment method of one of FIGS. 1 to 8.

### DETAILED DESCRIPTION

A nickel-based alloy according to this invention is described below. Throughout the following, the composition of the alloy will always be given in weight percent.

The composition of such an alloy is presented in Table 1 below. Nickel is not specified. Generally speaking, the amount of nickel represents the balance in order to reach 100%. Furthermore, as in any alloy composition, it is not technically possible to avoid residual impurities. Thus, although not mentioned in the compositions presented in this description, certain trace elements may be present. A person skilled in the art will be able to recognize whether an element is present as trace element or whether it has deliberately been added. Indeed, it is recognized that elements in trace form do not impart any particular properties to the alloy or alter any of the properties of the alloy.

TABLE 1

| Elements | Co | Cr | Mo | Al | Ti | C | B | Zr |
|---|---|---|---|---|---|---|---|---|
| Minimum | 4.0 | 15.3 | 1.6 | 1.65 | 2.8 | 0.01 | 0.003 | 0.01 |
| Maximum | 15.7 | 19.5 | 5.45 | 2.5 | 4.3 | 0.10 | 0.02 | 0.10 |

Thus, the present alloy comprises the elements cobalt, aluminum, and titanium, which are intended to form a hardening γ′ precipitation of ordered structure L1₂ and of composition (Ni,Co)₃(Al,Ti).

Furthermore, cobalt contributes to reinforcing the mechanical resistance to heat by solid solution hardening of the γ matrix and allows controlling the stability domains of the carbides of interest, MC (M═Ti, Mo) and M₂₃C₆(M═Cr, Mo).

The chromium content in particular allows promoting the oxidation resistance of the alloy while reducing the precipitation of weakness-inducing TCP phases (Topologically Close Pack phases, also known as Frank-Kasper phases). In addition, chromium participates in the formation of M₂₃C₆ carbides.

Molybdenum contributes to mechanically strengthening the alloy against heat. Its content has been optimized to maximize this strengthening while limiting the precipitation of σ or μ TCP phases considered to be weakening. The σ-type TCP phase is an intermetallic compound having no defined stoichiometric composition and having an electron/atom ratio of 6.2 to 7. It is a primitive unit cell of 30 atoms. The μ-type TCP phase has an ideal A₆B₇ stoichiometry. In addition, this element is part of the composition of MC and M₂₃C₆ type carbides. MC type carbides are intended to control grain size by anchoring grain boundaries during γ′ supersolvus treatment. Furthermore, as a first approximation, the TCP phases all have the same effect, in particular a reduction in the ductility of the alloy by creating potential crack initiation sites. In addition, the formation of TCP phases also contributes to reducing the solid solution reinforcement of the matrix because it pumps some of the atoms of the alloying elements.

Titanium participates in the formation of MC type carbides.

Carbon is present to control grain growth through the precipitation of MC carbides, and to reinforce the heat resistance of grain boundaries by forming M₂₃C₆ carbides.

The boron and zirconium elements also allow reinforcing the strength of grain boundaries over the entire operating temperature range, in particular up to 850° C.

The alloy may also comprise 6.0 weight % or less of iron, or even 4.0 weight % or less. Iron is an inexpensive element and allows reducing the density of the alloy as well as its cost. Furthermore, taking into account the iron content when seeking a composition suitable for the intended applications makes it possible to recycle iron-containing alloys for the production of the nickel-based alloy of the invention, and consequently to expand the range of usable recycled resources.

The alloy may also comprise 6.3 weight % or less of tungsten. Tungsten, in addition to or as a substitute for molybdenum, allows improving the mechanical behavior of the alloy when hot, in particular by solid solution hardening of the γ matrix. The added amount of molybdenum and tungsten in the alloy, in atomic percent, may also be between 2% and 5%. This avoids promoting the precipitation of TCP phases; in this case, in the formula for carbides of type M₂₃C₆, M═Cr, Mo, W.

The alloy may also comprise 0.4 weight % or less of niobium. When the alloy comprises niobium, the L1₂ ordered structure has the composition (Ni,Co)₃(Al,Ti,Nb) instead of (Ni,Co)₃(Al,Ti).

Taking a niobium content into account when seeking a composition suitable for the intended applications allows recycling alloys containing niobium for the production of the nickel-based alloy of the invention and consequently, expanding the range of usable recycled resources. The maximum limit of the range, i.e. 0.4%, allows preferential stabilization of titanium carbides over niobium carbides.

Thus, the composition of the alloy according to the invention is preferably according to Table 2, with nickel making up the balance.

TABLE 2

| Elem. | Co | Cr | Mo | Al | Ti | C | B | Zr | Fe | W | Nb |
|---|---|---|---|---|---|---|---|---|---|---|---|
| Min. | 4.0 | 15.3 | 1.6 | 1.65 | 2.8 | 0.01 | 0.003 | 0.01 | 0 | 0 | 0 |
| Max. | 15.7 | 19.5 | 5.45 | 2.5 | 4.3 | 0.10 | 0.02 | 0.10 | 6.0 | 6.3 | 0.4 |

Such an alloy has greater heat resistance than Waspaloy, in particular due to a higher mole fraction of γ′ precipitates. Thus, due to such a composition, this mole fraction is greater than 28%, in particular between 28 and 40%. In addition, it limits the mole fraction of γ′ precipitates to 40%. Furthermore, the solvus temperature of the γ′ precipitates is limited to 1120° C. This facilitates shaping of the alloy by ring rolling.

This composition also ensures that the sum of the atomic percents of elements Al, Ti and Nb is between 7 and 10 at %; which makes it possible to obtain a mole fraction of γ′ phases of between 28% and 40%. In addition, it ensures that the atomic ratio between the element Al on the one hand and the elements Ti and Nb on the other hand (Al/(Ti+Nb)) is between 0.85 and 1.2, thus promoting the precipitation of the γ′ phase over the η-NisTi phase, the latter being undesirable from the point of view of mechanical properties. In other words, the Ti content is optimized in the γ′ phase, which maximizes the mechanical strengthening of the alloy against heat, while avoiding any promotion of the formation of the 11 phase to the detriment of the γ′ phase.

This composition induces the precipitation of carbides at the grain boundaries, in particular M₂₃C₆ type carbides, which reinforces the creep resistance of the alloy at high temperature. In particular, carbides have a discrete distribution at the grain boundaries. They generally have a nodular shape that is smaller than 5 μm, advantageously smaller than 1 μm. The discrete distribution at the grain boundaries is made possible by combining the composition with an appropriate heat treatment described below.

The amount of M₂₃C₆ carbides may be between 0.4 and 1 mol %, advantageously between 0.5 and 0.75 mol %. This makes it possible to obtain both a sufficient population of carbides to ensure the desired hardening and to avoid saturation of the grain boundaries. Indeed, saturation of the grain boundaries promotes unwanted intragranular precipitation.

Furthermore, the solvus of M₂₃C₆ type carbides satisfies the criterion:

$$( {γ}^{′} solvus - {M}_{23} {C}_{6} ) \geq 40 ° C .$$

Compliance with this criterion allows a γ′ subsolvus heat treatment to be carried out without risking the precipitation of M₂₃C₆ type carbides at a temperature above 870° C. Indeed, beyond this temperature, the precipitation of M₂₃C₆ type carbides could preferentially take place in the form of films or platelets on the grain boundaries, which adversely impacts the crack propagation resistance.

Furthermore, the composition ensures a solvus of M₂₃C₆ type carbides that is above 900° C. Thus, redissolution of the carbides can be avoided during temperature spikes above 850° C. during operation, ultimately making it possible to avoid degrading the mechanical aspect.

Furthermore, the alloy has an intermediate grain size between ASTM 2 and 6, which represents a good compromise between the creep resistance at high temperature fostered by a coarse grain size, and the fatigue resistance fostered by a fine grain size.

This intermediate grain size is obtained in particular thanks to the presence of a controlled population of MC type carbides, which allows limiting grain enlargement during forging and during heat treatment at a temperature above the γ′ solvus. These carbides generally have a nodular shape, sometimes angular, in the presence of trace nitrogen, and a size smaller than 5 μm. Preferably, the molar quantity of MC type carbides is between 0.1 and 0.3% at a temperature higher than the solvus of the γ′ phases, for example at a γ′ solvus temperature of +40° C.

The presence of MC type carbides allows anchoring the grain boundaries 2 on the MC type carbides 3 during heat treatment (FIG. 9), which limits grain growth to the targeted value of between ASTM 2 and 6.

The mole fraction of MC type carbides, limited to 0.3%, makes it possible to avoid degrading the fatigue life via the formation of coarser carbides and carbonitrides (i.e. of a size greater than 5 μm) which is inherent to production by casting and forging.

Another way to limit the formation of coarse carbides is to have a solvus temperature for MC type carbides that is lower than the solidus of the alloy; which is made possible by the composition.

A preferred composition is according to the following Table 3, or to Table 4 when taking into account the amounts of Fe, W and Nb.

TABLE 3

| Elements | Co | Cr | Mo | Al | Ti | C | B | Zr |
|---|---|---|---|---|---|---|---|---|
| Minimum | 4.0 | 15.3 | 1.6 | 1.65 | 2.8 | 0.02 | 0.005 | 0.02 |
| Maximum | 15.7 | 19.5 | 5.45 | 2.5 | 4.3 | 0.06 | 0.01 | 0.06 |

TABLE 4

| Elem. | Co | Cr | Mo | Al | Ti | C | B | Zr | Fe | W | Nb |
|---|---|---|---|---|---|---|---|---|---|---|---|
| Min. | 4.0 | 15.3 | 1.6 | 1.65 | 2.8 | 0.02 | 0.005 | 0.02 | 0 | 0 | 0 |
| Max. | 15.7 | 19.5 | 5.45 | 2.5 | 4.3 | 0.06 | 0.01 | 0.06 | 6.0 | 6.3 | 0.4 |

These compositions ensure that the sum of the atomic percents of the elements Al, Ti and Nb is between 7 and 8.25 at %.

Another preferred composition is according to the following Table 5, or to Table 6 when taking into account the amounts of Fe, W and Nb.

TABLE 5

| Elements | Co | Cr | Mo | Al | Ti | C | B | Zr |
|---|---|---|---|---|---|---|---|---|
| Minimum | 4.0 | 15.3 | 1.6 | 1.80 | 3.5 | 0.02 | 0.005 | 0.02 |
| Maximum | 13.2 | 19.5 | 5.45 | 2.30 | 4.0 | 0.06 | 0.01 | 0.06 |

TABLE 6

| Elem. | Co | Cr | Mo | Al | Ti | C | B | Zr | Fe | W | Nb |
|---|---|---|---|---|---|---|---|---|---|---|---|
| Min. | 4.0 | 15.3 | 1.6 | 1.65 | 2.8 | 0.02 | 0.005 | 0.02 | 0 | 0 | 0 |
| Max. | 13.2 | 19.5 | 5.45 | 2.5 | 4.3 | 0.06 | 0.01 | 0.06 | 6.0 | 6.3 | 0.4 |

These compositions ensure that the sum of the atomic percents of the elements Al, Ti and Nb is between 8.5 and 9% at.

Yet another preferred composition is according to the following Table 7, or to Table 8 when taking into account the amounts of Fe, W and Nb.

TABLE 7

| Elements | Co | Cr | Mo | Al | Ti | C | B | Zr |
|---|---|---|---|---|---|---|---|---|
| Minimum | 4.0 | 15.3 | 1.6 | 2.0 | 4.05 | 0.02 | 0.005 | 0.02 |
| Maximum | 11.0 | 19.5 | 5.45 | 2.5 | 4.4 | 0.06 | 0.01 | 0.06 |

TABLE 8

| Elem. | Co | Cr | Mo | Al | Ti | C | B | Zr | Fe | W | Nb |
|---|---|---|---|---|---|---|---|---|---|---|---|
| Min. | 4.0 | 15.3 | 1.6 | 2.0 | 4.05 | 0.02 | 0.005 | 0.02 | 0 | 0 | 0 |
| Max. | 11.0 | 19.5 | 5.45 | 2.5 | 4.4 | 0.06 | 0.01 | 0.06 | 4.0 | 6.3 | 0.4 |

These compositions ensure that the sum of the atomic percents of the elements Al, Ti and Nb is between 9.25 and 10 at %. Furthermore, they correspond to compositions giving the highest molar content of γ′ precipitates, up to 40%.

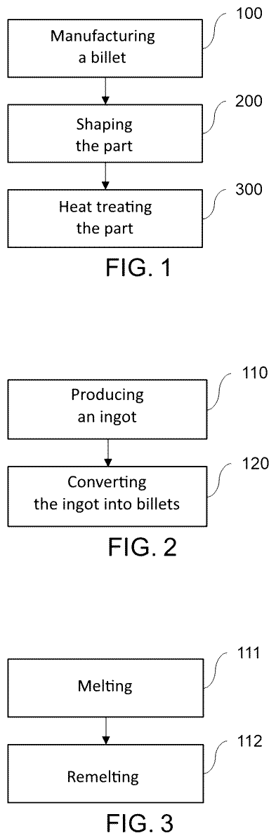

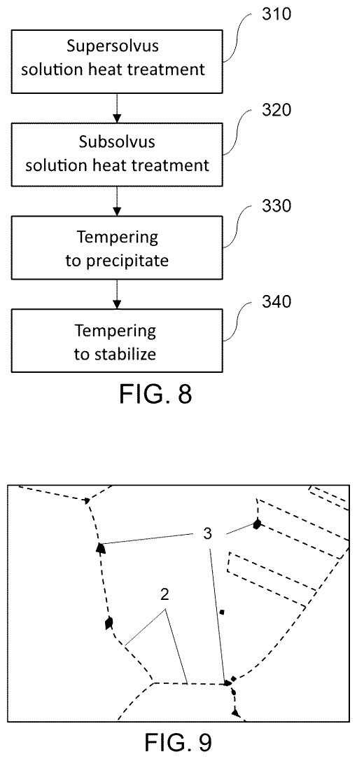

A method for manufacturing a part made of a nickel-based alloy as described above is described below with reference to FIGS. 1 to 8.

This method comprises manufacturing 100 a billet which has the same composition as that of the nickel-based alloy, shaping 200 the part, and heat treating 300 the part (FIG. 1).

Manufacturing 100 the billet may in particular comprise producing 110 an ingot and converting 120 the ingot into billets (FIG. 2). Producing 110 the ingot may be achieved by melting 111 materials that are chosen so as to obtain the composition of the nickel-based alloy as described above (FIG. 3). This first step in producing the ingot may be carried out in particular by vacuum induction melting (VIM). Producing 110 the ingot may also comprise one or more remelting processes 112. For example, this step comprises electroslag remelting (ESR) and/or vacuum arc remelting (VAR) (FIG. 3). These additional steps allow improving the inclusionary cleanliness of the ingot and minimizing macrosegregations.

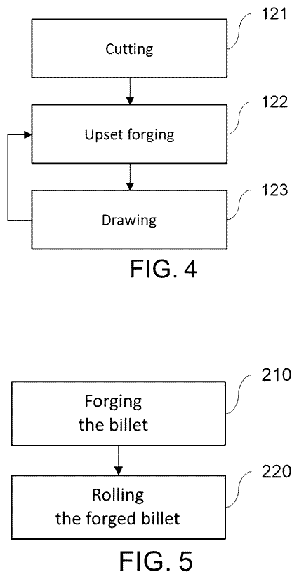

Converting 120 the ingot into billets may be carried out by forging after cutting 121 the ingot, in particular by successive operations of upset forging 122 and drawing 123 the nickel-based alloy in order to refine the solidification structure of the nickel-based alloy (FIG. 4).

Shaping 200 the part may comprise forging 210 the billet, in particular by upset forging the nickel-based alloy that forms the billet. Shaping the part may also comprise rolling 220 after forging, in particular ring rolling (FIG. 5).

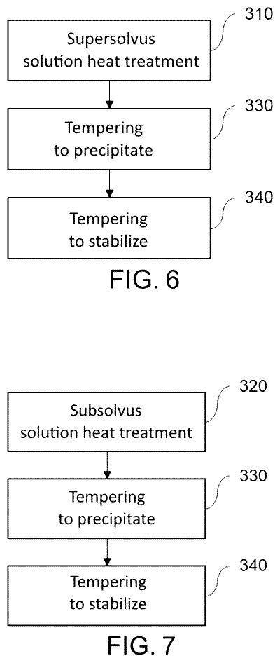

Heat treating 300 the part in particular comprises at least one treatment among γ′ supersolvus solution heat treatment 310 and γ′ subsolvus solution heat treatment 320 (FIGS. 6 to 8). γ′ supersolvus solution heat treatment 310 allows growth of the grains to a desired size and in particular between ASTM 2 and 6, for example ASTM 4. For example, γ′ supersolvus solution heat treatment 310 is carried out by heating at a temperature 10 to 40° C. higher than the γ′ solvus, in particular for a period of between 1 and 8 h. γ′ subsolvus solution heat treatment 320 allows refining the size of the γ′ precipitates and improving the mechanical strength of the alloy. This solution heat treatment is followed by quenching. For example, γ′ subsolvus solution heat treatment 320 is carried out by heating at a temperature 10 to 40° C. lower than the γ′ solvus, in particular for a period of between 1 and 8 h. γ′ subsolvus solution heat treatment 320 may be carried out directly after shaping 200 the part, when the desired grain size has already been reached during forging.

Heat treating 300 the part may further comprise a tempering 330 to precipitate M₂₃C₆ type carbides, in particular after γ′ supersolvus solution heat treatment 310 and/or γ′ subsolvus solution heat treatment 320. For example, this tempering 330 to precipitate M₂₃C₆ type carbides is carried out by heating to a temperature of between 825° C. and 870° C., preferably between 840° C. and 860° C., for example approximately 850° C., in particular for 4 to 8 hours.

Heat treating 300 the part may further comprise a tempering 340 to stabilize the populations of γ′ precipitates, in particular at a temperature close to the targeted operating temperature, for example between 760° C. and 825° C. (FIG. 6), preferably between 790° C. and 810° C., for example approximately 800° C., typically after tempering 330 to precipitate. For example, this tempering 340 to stabilize is carried out by heating between 76° and 825° C., in particular for 4 to 16 h.

Thus, heat treating the part may in particular include the following combinations (referring to the differentiating number in references 310, 320, 330 and 340): 1+3, 1+4, 2+3, 2+4, 1+2+3, 1+2+4, 1+3+4, 2+3+4, 1+2+3+4.

### EXAMPLES

Table 9 gives the mass composition of twenty-four examples according to this invention (Ex. 1 to Ex. 24) and a comparative example (Ex. C11. Table 10 gives the properties for these examples.

TABLE 9

| Elem. | Co | Cr | Mo | Al | Ti | C | Zr | B | Fe | W | Nb |
|---|---|---|---|---|---|---|---|---|---|---|---|
| Ex. 1 | 12.5 | 17.4 | 4.65 | 1.90 | 3.38 | 0.030 | 0.05 | 0.006 | 0 | 0 | 0 |
| Ex. 2 | 8.3 | 17.5 | 4.67 | 2.03 | 3.81 | 0.040 | 0.05 | 0.006 | 0 | 0 | 0 |
| Ex. 3 | 10.2 | 15.3 | 4.55 | 1.98 | 3.72 | 0.030 | 0.05 | 0.006 | 0 | 3.17 | 0 |
| Ex. 4 | 6.3 | 19.5 | 2.57 | 2.05 | 3.85 | 0.040 | 0.05 | 0.006 | 0 | 0 | 0 |
| Ex. 5 | 15.6 | 19.3 | 3.40 | 1.67 | 2.97 | 0.030 | 0.05 | 0.006 | 0 | 0 | 0 |
| Ex. 6 | 8.4 | 15.7 | 3.84 | 2.40 | 4.26 | 0.030 | 0.05 | 0.006 | 0 | 0 | 0 |
| Ex. 7 | 15.5 | 15.5 | 5.45 | 1.65 | 3.35 | 0.030 | 0.05 | 0.006 | 0 | 0 | 0 |
| Ex. 8 | 6.3 | 15.8 | 2.99 | 2.17 | 3.84 | 0.030 | 0.05 | 0.006 | 5.98 | 0 | 0 |
| Ex. 9 | 8.3 | 15.5 | 1.68 | 2.12 | 4.19 | 0.030 | 0.05 | 0.006 | 0 | 3.22 | 0 |
| Ex. 10 | 10.1 | 15.3 | 1.64 | 1.84 | 3.68 | 0.030 | 0.05 | 0.006 | 0 | 6.27 | 0 |
| Ex. 11 | 4.0 | 15.8 | 2.99 | 2.17 | 3.50 | 0.030 | 0.05 | 0.006 | 3 | 0 | 0.40 |
| Ex. 12 | 12.1 | 16.8 | 1.60 | 1.65 | 2.85 | 0.030 | 0.05 | 0.006 | 1.90 | 6.26 | 0 |
| Ex. 13 | 12.5 | 15.7 | 3.40 | 2.03 | 3.39 | 0.032 | 0.05 | 0.006 | 0 | 0 | 0 |
| Ex. 14 | 15.7 | 17.5 | 3.40 | 1.91 | 3.39 | 0.030 | 0.05 | 0.006 | 0 | 0 | 0 |
| Ex. 15 | 12.0 | 17.0 | 4.00 | 1.70 | 2.80 | 0.035 | 0.05 | 0.006 | 3 | 4 | 0 |
| Ex. 16 | 12.0 | 18.0 | 5.00 | 2.00 | 3.50 | 0.025 | 0.05 | 0.006 | 1 | 1 | 0 |
| Ex. 17 | 8.4 | 15.7 | 2.98 | 2.01 | 2.97 | 0.053 | 0.05 | 0.006 | 0 | 0 | 0 |
| Ex. 18 | 12.3 | 15.4 | 3.75 | 2.11 | 3.74 | 0.021 | 0.05 | 0.006 | 3.88 | 3.19 | 0 |
| Ex. 19 | 8.4 | 15.7 | 4.67 | 2.27 | 4.24 | 0.030 | 0.05 | 0.006 | 0 | 0 | 0 |
| Ex. 20 | 4.2 | 15.6 | 3.40 | 1.79 | 3.39 | 0.030 | 0.05 | 0.006 | 4.0 | 0 | 0 |
| Ex. 21 | 10.4 | 15.6 | 4.24 | 1.91 | 3.38 | 0.030 | 0.05 | 0.006 | 3.95 | 0 | 0 |
| Ex. 22 | 8.2 | 15.3 | 3.74 | 1.87 | 3.73 | 0.030 | 0.05 | 0.006 | 1.93 | 3.18 | 0 |
| Ex. 23 | 4.1 | 15.3 | 4.15 | 1.98 | 3.73 | 0.030 | 0.05 | 0.006 | 1.93 | 3.18 | 0 |
| Ex. 24 | 6.3 | 18.7 | 2.58 | 2.42 | 4.30 | 0.030 | 0.05 | 0.006 | 0 | 0 | 0 |
| Ex. C 1 | 11.0 | 15.5 | 4.50 | 1.94 | 3.64 | 0.030 | 0.05 | 0.006 | 0 | 0 | 0.78 |

TABLE 10

| | P1 | P2 | P3 | P4 | P5 | P6 | P7 | P8 | P9 |
|---|---|---|---|---|---|---|---|---|---|
| Ex. 1 | 1.00 | 8.0 | 0.62 | 1058 | 956 | 102 | 0.16 | 1248 | 1295 |
| Ex. 2 | 0.94 | 8.8 | 0.74 | 1080 | 995 | 85 | 0.16 | 1271 | 1286 |
| Ex. 3 | 0.94 | 8.8 | 0.63 | 1075 | 956 | 119 | 0.16 | 1260 | 1283 |
| Ex. 4 | 0.94 | 8.8 | 0.75 | 1081 | 1022 | 59 | 0.16 | 1267 | 1288 |
| Ex. 5 | 1.00 | 7.0 | 0.62 | 1030 | 935 | 95 | 0.19 | 1258 | 1299 |
| Ex. 6 | 1.00 | 10.0 | 0.63 | 1106 | 988 | 118 | 0.12 | 1254 | 1291 |
| Ex. 7 | 0.88 | 7.5 | 0.57 | 1033 | 893 | 140 | 0.18 | 1245 | 1298 |
| Ex. 8 | 1.00 | 9.0 | 0.60 | 1059 | 950 | 109 | 0.15 | 1266 | 1290 |
| Ex. 9 | 0.90 | 9.5 | 0.62 | 1088 | 960 | 128 | 0.14 | 1261 | 1289 |
| Ex. 10 | 0.89 | 8.5 | 0.61 | 1060 | 933 | 127 | 0.17 | 1266 | 1282 |
| Ex. 11 | 1.04 | 8.9 | 0.58 | 1060 | 910 | 150 | 0.18 | 1281 | 1310 |
| Ex. 12 | 1.03 | 7.1 | 0.61 | 1023 | 926 | 97 | 0.19 | 1252 | 1278 |
| Ex. 13 | 1.06 | 8.3 | 0.57 | 1050 | 926 | 124 | 0.13 | 1204 | 1313 |
| Ex. 14 | 1.00 | 8.0 | 0.61 | 1054 | 925 | 129 | 0.19 | 1282 | 1295 |
| Ex. 15 | 1.08 | 7.1 | 0.62 | 1020 | 932 | 88 | 0.20 | 1254 | 1280 |
| Ex. 16 | 1.01 | 8.4 | 0.50 | 1074 | 983 | 91 | 0.11 | 1227 | 1284 |
| Ex. 17 | 1.20 | 7.7 | 1.00 | 1020 | 950 | 70 | 0.25 | 1199 | 1324 |
| Ex. 18 | 1.00 | 9.0 | 0.41 | 1073 | 920 | 153 | 0.12 | 1260 | 1264 |
| Ex. 19 | 0.95 | 9.8 | 0.63 | 1102 | 985 | 117 | 0.13 | 1255 | 1287 |
| Ex. 20 | 0.94 | 7.8 | 0.61 | 1025 | 957 | 68 | 0.12 | 1159 | 1311 |
| Ex. 21 | 1.00 | 8.0 | 0.62 | 1042 | 923 | 119 | 0.18 | 1254 | 1297 |
| Ex. 22 | 0.89 | 8.5 | 0.63 | 1061 | 950 | 111 | 0.17 | 1259 | 1284 |
| Ex. 23 | 0.94 | 8.8 | 0.64 | 1066 | 992 | 74 | 0.12 | 1206 | 1290 |
| Ex. 24 | 1.00 | 10.0 | 0.56 | 1111 | 1033 | 78 | 0.10 | 1261 | 1282 |
| Ex. C 1 | 0.85 | 9.1 | 0 | 1079 | 838 | 241 | 0.22 | 1302 | 1299 |

where P1 is the atomic ratio Al/(Ti+Nb); P2 is the sum of the atomic percents of elements Al, Ti and Nb; P3 is the mole percent of M₂₃C₆ type carbides determined at 850° C.; P4 is the γ′ solvus (° C.); P5 is the solvus of M₂₃C₆ type carbides (° C.); P6 is the difference between the γ′ solvus and the solvus of M₂₃C₆ type carbides (° C.); P7 is the mole percent of MC type carbides, 40° C. above the γ′ solvus temperature; P8 is the solvus of MC type carbides (° C.); and P9 is the solidus (° C.).

1. A nickel-based alloy comprising, in weight percent:
4.0 to 15.7% cobalt;
15.3 to 19.5% chromium;
1.6 to 5.45% molybdenum;
1.65 to 2.5% aluminum;
2.8 to 4.3% titanium;
0.01 to 0.10% carbon;
0.003 to 0.02% boron;
0.01 to 0.10% zirconium;
0 to 6.0% iron;
0 to 6.3% tungsten; and
0 to 0.4% niobium,
nickel representing the balance to 100%.

2. The nickel-based alloy according to claim 1, comprising, in weight percent:
0.02 to 0.06% carbon;
0.005 to 0.01% boron; and
0.02 to 0.06% zirconium.

3. The nickel-based alloy according to claim 2, comprising, in weight percent:
1.65 to 2.10% aluminum; and
2.8 to 3.45% titanium.

4. The nickel-based alloy according to claim 2, comprising, in weight percent:
4.0 to 13.2% cobalt;
1.80 to 2.30% aluminum; and
3.5 to 4.0% titanium.

5. The nickel-based alloy according to claim 2, comprising, in weight percent:
4.0 to 11.0% cobalt;
2.0 to 2.50% aluminum; and
4.05 to 4.4% titanium.

6. A method for manufacturing a part made of a nickel-based alloy according to claim 1, the method comprising:
manufacturing a billet which has the same composition as that of the nickel-based alloy;
shaping the part; and
heat treating the part.

7. The method according to claim 6, wherein heat treating the part comprises at least one treatment among:
a γ′ supersolvus solution heat treatment, preferably at a temperature that is 10 to 40° C. higher than the γ′ solvus; and
a γ′ subsolvus solution heat treatment, preferably at a temperature that is 10 to 40° C. lower than the γ′ solvus.

8. The method according to claim 6, wherein the heat treatment further comprises:
a tempering to precipitate M₂₃C₆ type carbides, preferably by heating to a temperature between 825 and 870° C.; and
optionally a tempering to stabilize the populations of γ′ precipitates, preferably at a temperature between 76° and 825° C.

9. An aeronautical part made of an alloy according to claim 1, in particular a turbine casing.

10. The method for manufacturing a part made of a nickel-based alloy according to claim 2, the method comprising:
manufacturing a billet which has the same composition as that of the nickel-based alloy;
shaping the part; and
heat treating the part.

11. The method for manufacturing a part made of a nickel-based alloy according to claim 3, the method comprising:
manufacturing a billet which has the same composition as that of the nickel-based alloy;
shaping the part; and
heat treating the part.

12. The method for manufacturing a part made of a nickel-based alloy according to claim 4, the method comprising:
manufacturing a billet which has the same composition as that of the nickel-based alloy;
shaping the part; and
heat treating the part.

13. The method for manufacturing a part made of a nickel-based alloy according to claim 5, the method comprising:
manufacturing a billet which has the same composition as that of the nickel-based alloy;
shaping the part; and
heat treating the part.

14. The method according to claim 7, wherein the heat treatment further comprises:
a tempering to precipitate M₂₃C₆ type carbides, preferably by heating to a temperature between 825 and 870° C.; and
optionally a tempering to stabilize the populations of γ′ precipitates, preferably at a temperature between 76° and 825° C.

15. An aeronautical part made of an alloy according to claim 2, in particular a turbine casing.

16. An aeronautical part made of an alloy according to claim 3, in particular a turbine casing.

17. An aeronautical part made of an alloy according to claim 4, in particular a turbine casing.

18. An aeronautical part made of an alloy according to claim 5, in particular a turbine casing.
